(19) United States
(12) Patent Application Publication
(10) Pub. No.: US 2009/0294469 A1
(43) Pub. Date: Dec. 3, 2009

(54) Mass-Based Powder Dispensing

(75) Inventors: Marc Poulain, Champigny-Sur-Marne (FR); Oliver Bredow, Bernau (DE)

Correspondence Address: SHUMAKER & SIEFFERT, P. A., 1625 RADIO DRIVE, SUITE 300, WOODBURY, MN, 55125, US

(73) Assignee: Ecolab Inc.

(21) Appl. No.: 12/130,541

(22) Filed: May 30, 2008

(51) Int. Cl. B67D 5/08

(52) U.S. Cl. 222/1; 222/58; 222/133; 222/71; 222/23; 222/64; 222/145.6; 222/145.7; 222/56

(57) ABSTRACT

Mass-based dispensing of a powder product includes a system that dispenses a powder product containing an active ingredient from a product container. The system initiates a dispense cycle at a first, higher dispense rate. The system continuously determines, as the powder product is dispensed, the amount or weight of the powder product that has been dispensed. Once a transition criteria has been satisfied, the system adjusts the dispense rate to a second, lower dispense rate. The system dispenses the powder product at the second, lower dispense rate until a requested amount of the powder product has been dispensed.

### TECHNICAL FIELD

The invention relates generally to the dispensing of powdered materials.

### BACKGROUND

Many applications make use of automated dispensing of powdered materials. Oftentimes a specified amount of a powdered material, such as a powdered chemical product, is to be mixed with a diluent to form a stock solution having a known concentration. The stock solution is then dispensed in metered doses to its end use. Examples of these stock solutions include stock cleaning solutions having a known concentration of an active cleaning, disinfecting or sanitizing ingredient(s). Stock cleaning solutions are used extensively in many industrial and commercial applications such as commercial laundry operations, industrial warewashing, restaurants, hotels, hospitals, etc.

In order to properly form a solution having the desired concentration, it is often necessary to know how much of the powder product has been dispensed. There are at least two types of systems that have been developed to determine the amount of a powder product that has been dispensed. One is a time-based process in which the powder product is dispensed for a certain amount of time known to result in somewhat less than the desired dispense weight. The product is weighed and the difference between the amount of powder dispensed and the amount of product desired is determined. Next, the powder is dispensed for a smaller amount of time calculated to achieve a dispensed amount closer to the desired dispense amount. The amount of product dispensed is then weighed again. This process continues, with powder being dispensed for incrementally smaller amounts of time until the desired dispense weight is achieved. One drawback of this batch-wise process is that it can be relatively slow and therefore not suitable for applications that are time-critical.

Another method that has been utilized is to test the conductivity of the concentrate solution to determine the amount of product that has been dispensed. Again, this system has its own unique problems such as the necessity of adding chemistry to the resulting solution to allow the active ingredient concentration to be tested. Further, the conductivity based dispensers typically do not give any information concerning the total amount (weight) of powder product dispensed, only the concentration of the active ingredient. In addition, these dispensers may suffer from inaccuracy because the conductivity, and therefore the concentration measurement, is also influenced by product concentration as a function of temperature and total conductivity.

### SUMMARY

In general, the invention relates to mass-based powder dispensing in which a powder product containing an active ingredient is dispensed from a product container. A dispense cycle is initiated at a first, higher dispense rate. The amount or weight of the powder product that has been dispensed is continuously determined as the product is dispensed. Once a transition criteria is satisfied, the dispense rate is adjusted to a second, lower dispense rate. The system dispenses the powder product at the second, lower dispense rate until a requested amount of the powder product has been dispensed.

In one embodiment, the invention is directed to a method comprising dispensing a powder product containing an active ingredient from a product container at a first, higher dispense rate, continuously determining, as the powder product is dispensed, a combined weight of the product container and the powder product remaining in the product container, determining when a transition criteria has been satisfied based on the combined weight, adjusting the dispense rate to a second, lower dispense rate when the transition criteria has been satisfied, determining when a requested amount of the powder product has been dispensed from the product container based on the combined weight, and discontinuing the dispensing of the powder product when the requested amount of the powder product has been dispensed.

In another embodiment, the invention is directed to a system comprising a dispenser that dispenses a powder product containing an active ingredient from a product container, a weigh assembly that continuously determines, as the powder product is dispensed, a current weight of the product container corresponding to a current dispensed amount of powder product, and a controller that determines when a transition criteria has been satisfied based on the current weight and determines when a requested amount of the powder product has been dispensed based on the current weight of the product container, wherein the dispenser dispenses at a first, higher dispense rate until the transition criteria has been satisfied and then dispenses at a second, lower dispense rate until a requested amount of the powder product has been dispensed.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a generalized schematic diagram illustrating an example mass-based powder dispensing system of the present invention.

FIG. 2 is a block diagram illustrating example electronic components for the mass-based powder dispensing system shown in FIG. 1.

FIG. 3 is a flowchart illustrating an example process by which controller 150 controls dispensing of a powder product.

FIG. 4 is a block diagram illustrating an example vibration unit and pneumatic control loops.

FIG. 5 is a diagram of a product container showing example locations of a container full sensor and a container empty sensor.

FIG. 6 is a flow chart illustrating one example of a method for automatically refilling a product container.

FIG. 7 is a diagram illustrating one example configuration of the weigh assembly that continuously measure the weight of the product container.

### DETAILED DESCRIPTION

Many applications make use of automated dispensing of powdered materials. Oftentimes a specified amount of a powdered material, such as a powdered chemical product, is to be mixed with a diluent to form a stock solution having a known concentration. The stock solution, or use solution as it is often referred to, is then dispensed in metered doses to one or more dosing points. Examples of these stock solutions include stock cleaning solutions having a known concentration of an active cleaning, disinfecting or sanitizing ingredient(s). Stock cleaning solutions are used extensively in many industrial and commercial applications such as commercial laundry operations, industrial warewashing, restaurants, hotels, hospitals, etc.

In order to properly form a use solution from the combination of a powder product and a diluent that has the desired concentration of an active ingredient, it may be desirable to know how much (e.g., the weight) of the powder product has been dispensed. To that end, the present invention relates to mass-based powder dispensing in which a powder product containing an active ingredient is dispensed from a product container. At the initiation of a dispense cycle, the dispenser dispenses the powder product at a first, higher dispense rate. The amount or weight of the powder product that has been dispensed is continuously determined as the product is dispensed. Once a transition criteria has been satisfied, the dispense rate is automatically adjusted to a second, lower dispense rate. The system dispenses the powder product at the second, lower dispense rate until a requested amount of the powder product has been dispensed.

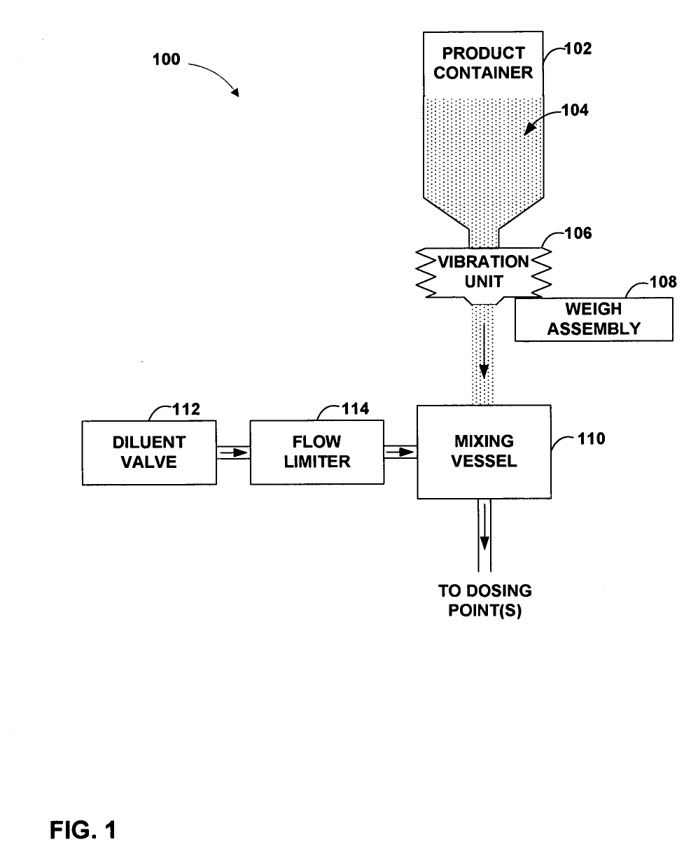

FIG. 1 is a generalized schematic diagram illustrating an example mass-based powder dispensing system of the present invention. It shall be understood that the location and placement of the various system components in the Figures are representational only and that the invention is not limited in this respect. Mass-based powder dispensing system 100 (herein referred to as “dispensing system 100” or simply “system 100”) includes a vibration unit 106 fitted onto the outlet section of a product container 102. Product container 102 contains a powder product 104 that, when mixed with a diluent in the proper amounts, forms a use solution having a desired concentration of an active ingredient. Vibration unit 106 transmits high frequency vibration energy to product container 102, thus delivering (dispensing) the powder product 104 from product container 102 into a mixing vessel 110. The dispense rate (the amount of product dispensed per unit time) may be controlled by the frequency of the vibration energy produced by vibration unit 106.

A dispense cycle begins at a first, higher dispense rate. As soon as a transition criteria has been satisfied, system 100 adjusts the dispense rate to a second, lower dispense rate. The dispenser then dispenses powder product 104 until a requested amount of the powder product has been dispensed.

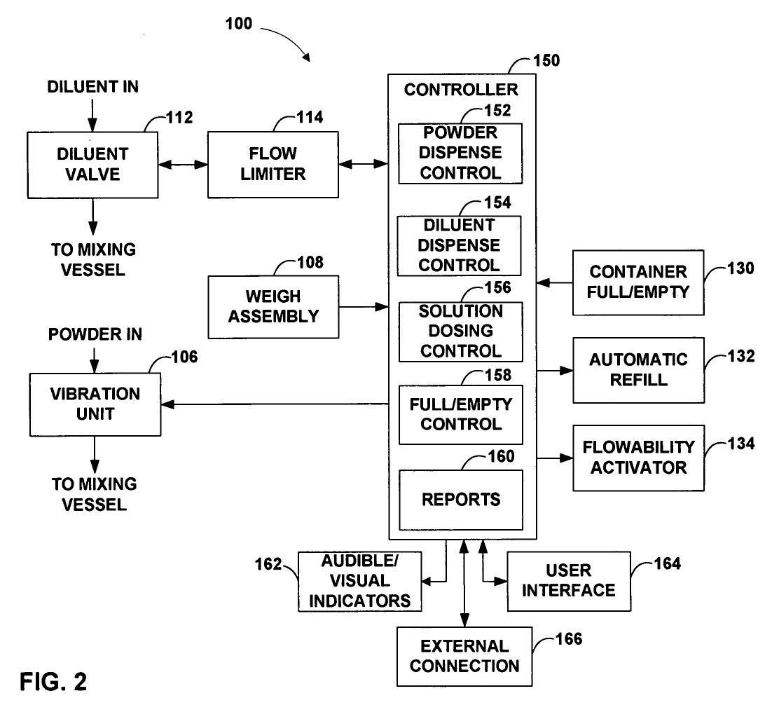

In the example dispensing system 100 shown in FIG. 1, weigh assembly 108 supports both vibration unit 106 and product container 102. Weigh assembly 108 continuously determines a current weight of vibration unit 106 and product container 102 as powder product 104 is dispensed during a dispensing cycle. A controller (see FIG. 2) receives the current weight and compares the current weight to an initial weight of the vibration unit 106 and the product container 102 at the initiation of the dispensing cycle to determine whether the transition criteria has been satisfied and/or the requested amount of the powder product has been dispensed. It shall be understood that although the example system 100 is described herein is one in which the weigh assembly 108 supports the product container 102 and the vibration unit 106, it shall be understood that this need not be the case. For example, the vibration unit need not be supported by the weigh assembly 108 in order to determine the current weight of the product container or to determine the amount of powder product dispensed. Also, depending upon the logistics of the system set up, other components may also be supported by weigh assembly 108. Those of skill in the art will readily appreciate that the invention is not limited in this respect.

In parallel to the dispensing of powder product 104, a diluent valve 112 opens and delivers a diluent (e.g., water) to mixing vessel 110. To prevent excessive amounts of water from entering the mixing vessel, a flow limiter 114 limits the amount of diluent delivered to a maximum amount. For example, flow limiter 114 may limit the flow of diluent to 10 litres/minute (L/min). However, it shall be understood that any flow rate could be used, such any flow rate between 1 L/min and 25 L/min, and the invention is not limited in this respect. Alternatively, delivery of diluent to mixing vessel 110 may be controlled via a pump in combination with a diluent flow meter.

After the use solution has been formed in mixing vessel 110, the use solution may be delivered to one or more dosing points. Dosing of the use solution (e.g., delivery in metered amounts to the one or more dosing points) from mixing vessel 110 is controlled via valves located at each dosing point. Alternatively, dosing of the use solution to the one or more dosing points may be controlled via a pump in combination with a solution dosing flow meter.

FIG. 2 is a block diagram illustrating example electronic components for the mass-based powder dispensing system shown in FIG. 1. Dispensing system 100 includes a controller 150 including a programmable microprocessor and a number of software modules 152-158 which monitor and control the various operations of dispensing system 100. Inputs to controller 150 include information from diluent flow meter 114 concerning the amount of diluent delivered to the mixing vessel 110, information from solution dosing flow meter 118 concerning the amount of use solution delivered to each of the various dosing points, and the current weight information from weigh assembly 108. Corresponding outputs of controller 150 include control signals to diluent flow meter 114 that control the amount of diluent delivered to mixing vessel 110, control signals to solution dosing flow meter 118 that control the amount of use solution delivered to each of the various dosing points, and controls signals to vibration unit 106 that control the dispense rate of the powder product.

Controller 150 may also receive information from container full/empty sensors 130. Container full/empty sensors 130 may include a container empty sensor that senses when product container 102 is substantially empty and generates a corresponding “container empty” signal. Container full/empty sensors 130 may also include a container full sensor that senses when product container 102 is substantially full and generates a corresponding “container full” signal.

Dispensing system 100 may also include a flowability activator 134 that facilitates flow of powder product 104 from product container 102. Flowability activator 134 may be fitted, for example, on the outside wall of product container 102. Flowability activator 134 transmits mechanical stresses to the outside wall of product container 102, similar to a blow from a hammer that may loosen crusts of powder product built up on the interior side walls of the product container and/or break up so-called “bridges” of powder product 104 inside of product container 102. Flowability activator 134 may include a pneumatic hammer that delivers a violent impact on the wall of product container 104, thus leading to the detachment of the crusts or the collapse of a material bridge. Flowability activator 134 may operate in a continuous or discontinuous manner, and may be electrically or pneumatically controlled. Controller 150 may control impulses delivered by flowability activator 134 periodically or at other times as necessary.

Data generated by dispensing system 100 may be stored in a system memory (not shown). Such data may include the amount of powder product dispensed, volume of diluent delivered to the mixing vessel, amount of use solution delivered to the various dosing points, container full/empty information, as well as system parameters such as target dispense amounts, requested amounts, transition criteria, dispense rates, etc. Such data may include a time stamp indicating when the data was received or generated. The system memory may include a solid state, non-volatile memory device, the disk storage unit, a disk drive unit, or other storage medium units coupled to the system 100.

As mentioned above, controller 150 is programmed via software modules 152-158, which control the various operations of dispensing system 100. Powder dispense control module 152 controls the dispensing of powder product 104 from the product container. For example, powder dispense control module 152 controls initiation and discontinuation of the powder dispensing cycles, controls the dispense rate(s) of vibration unit 106, determines when the transition criteria has been satisfied, and determines when the requested amount of powder product has been dispensed.

Diluent dispense control module 154 controls the dispensing of diluent into mixing vessel 110. For example, diluent dispense control module 154 controls initiation and discontinuation of the diluent dispensing cycles, controls the flow rate(s) and amount of fluid delivered by diluent delivery pump 112 via diluent flow meter 114.

As discussed above, dosing of the use solution to the one or more dosing points may be controlled via valves located at each dosing site. Alternatively, solution dosing control module 156 may control the dispensing of use solution to the one or more dosing points. For example, solution dosing control module 156 controls initiation and discontinuation of use solution dispensing cycles, and controls the flow rate(s) and amount of use solution delivered by the solution delivery pump 116 via solution dosing flow meter 118.

Full/empty control module 158 receives the container empty and/or container full signals from container full/empty sensors 130. In response to receiving a container empty signal, full/empty control module 158 may one or more courses of action. For example, full/empty control module 158 may activate a container empty indicator, such as a visual or audible indicator 162, to notify a user or service technician that the product container needs to be changed or refilled. As another example, controller 150 may initiate and control an automatic refill process. During the automatic refill process, full/empty control module 158 controls operation of automatic refill components 132. For example, automatic refill components 132 may include a flow control device that opens in response to the container empty signal and allows additional powder product to flow into product container 102. Full/empty control module 158 may further close the flow control device in response to receipt of the container full signal to stop flow of additional powder product into product container 102.

Report generation module 160 generates reports providing analysis of the data monitored and generated by dispensing system 100. Such reports may include, for example, results from an analysis related to the type of powder product dispensed, amount of powder product dispensed per dispensing cycle, total amount of powder product dispensed, type of use solution produced, amount (volume) of use solution produced per dispense cycle and/or over time, amount (volume) of use solution dispensed per dosing cycle, amount of use solution dispensed per dispensing point, etc. Costs analyses and efficiency of may also be generated by the report generation module 160 and therefore included on a report for evaluation by a service technician or corporate entity.

The result presented in the report may include a comparison with targets to determine whether dispensing system 100 is performing properly, whether preventive maintenance should be performed, whether system parameters should be adjusted, or to identify other problems. Such reports permit detailed analysis and comparison of the operation of the multiple dispensing systems 100, and permit a corporate entity to view operation of an entire fleet of dispensing systems in a single report. Any or all of these reports may be generated periodically (e.g., hourly, daily, weekly, monthly, annually, etc.) or on demand when requested by a service technician or corporate entity responsible for operation of the dispensing system 100. These reports provide a mechanism through which chemical usage trends of multiple individual dispensing systems 100 can be monitored and managed. Generation of reports allow service technicians or corporate entities to provide long distance analysis of the process situation, identify potential for improvements, and make corrections remotely. The reports may include tables, graphs, text or other appropriate medium to communicate the data.

Dispensing system 100 may also include other audible or visual indicators 162 that may be used to indicate various system status information. Controller 150 may display various system parameters and/or reports on user interface 164. User interface 164 may allow a user or service technician to adjust various system parameters, such as powder dispense rate(s), transition criteria, requested amount(s), desired diluent volume, etc., or to install software updates. An external connection 166, such as a telephone, cell phone, or internet connection, allows controller 150 to automatically generate and send outbound messages such as e-mails, voice mails, text messages, reports and the like to a service technician or corporate entity responsible for operation of the dispensing system 100.

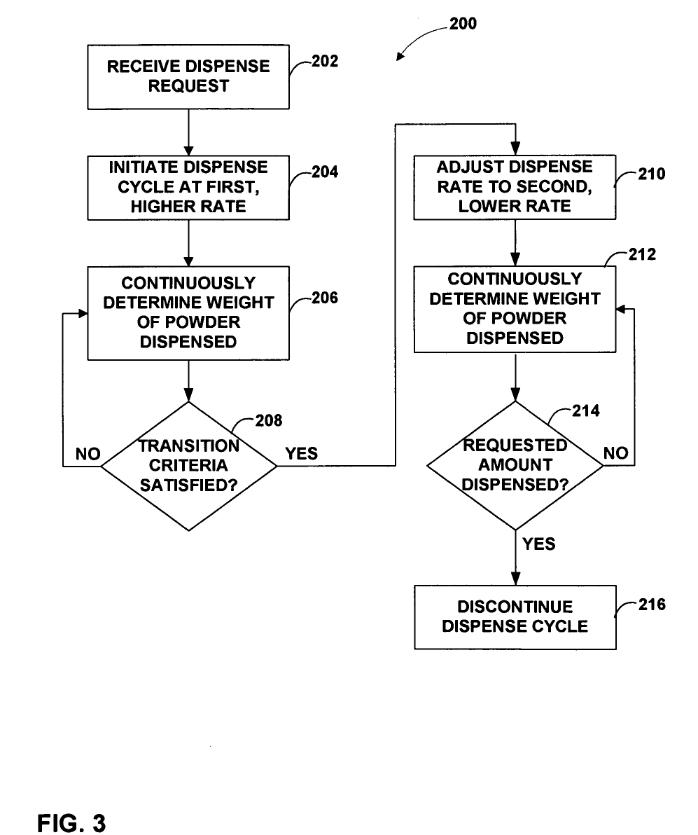

FIG. 3 is a flowchart illustrating an example process 200 by which powder dispense control module 152 of controller 150 controls dispensing of a powder product. Controller 150 receives a dispense request (202). The dispense request may be generated externally, such as by a user or service technician either on site or remotely, or may be automatically generated after emptying of the mixing vessel. Upon receipt of the dispense request (202) controller 204 initiates a dispense cycle at a first, higher dispense rate (204). Controller sends control signals to vibration unit 106 that cause vibration unit to dispense powder product 104 at the first, higher dispense rate. As the powder product is dispensed, weigh assembly 108 continuously determines the current weight of the product container, including the weight of any product remaining in the product container. Controller 150 receives the current weight information from weigh assembly 108 and continuously determines the weight of powder product that has been dispensed since the beginning of the dispensing cycle (206). To do this, controller 150 may determine the difference between the current weight of the product container having a current amount of powder product obtained by the weigh assembly 108 and the initial weight of the product container having an initial amount of powder product obtained at the beginning of the dispense cycle. This weight differential corresponds to the amount of weight lost from the product container and therefore the amount (weight) of powder product dispensed currently dispensed.

Controller 150 also determines whether the transition criteria has been satisfied (208). The transition criteria determine the point during a dispensing cycle at which dispensing system adjusts the dispense rate from the first, higher dispense rate to the second, lower dispense rate. If the transition criteria has not been satisfied, controller 150 continues to monitor the weight of powder product as it is being dispensed. When the transition criteria has been satisfied (208), controller 150 adjusts the dispense rate of the system to the second, lower dispense rate that is relatively lower than the first, higher dispense rate (210).

The transition criteria may be adjusted based on the flow ability behaviour of the powder product. Products with low flow ability can be dosed nearly to the requested dosage amount at the first, higher dispense rate. For powder products having high flow ability then the system may adjust the dispense rate early enough in the dispensing cycle to ensure that more than the requested amount of powder product is not dispensed.

The transition criteria may be expressed in several ways. For example, the transition criteria may focus on the amount dispensed since the beginning of the dispensing cycle, and require that at least a predefined amount of powder product or a percentage of the requested amount has been dispensed before the system adjusts from the first, higher dispense rate to the second, lower dispense rate. Alternatively, the transition criteria may focus on the requested amount, and require that less than a predefined amount of powdered product remains to be dispensed. For example, for a requested amount of 1000 grams, the transition criteria may be set such that the difference between the requested amount and the dispensed amount is at least 250 grams. In this example, as soon as weigh assembly 108 detects a weight differential of 750 grams, dispensing system 100 will switch to the second, lower dispense rate until the requested amount of 1000 grams has been dispensed. The transition criteria may alternatively be set such that the weight differential is at least 750 grams. It shall be understood that the transition criteria may vary, and that the precise manner of setting or determining whether the transition criteria has been satisfied may vary, and that the invention is not limited in this respect.

As one example, the transition criteria may include a transition amount. Determination of whether the transition criteria has been satisfied may include, for example, a comparison of the current weight of powder product dispensed with the transition amount. The relative magnitude of the transition amount as compared to the requested amount may thus depend upon several factors, such as the use solution being prepared, the particle size and mass of the powder product, the flow ability of the powder product, the type of powder product (e.g., spray products, gel granules, mixed products, etc.) the specifications and capabilities of the vibration unit, etc. The transition amount can be adjusted anywhere from 0% of the requested amount (in which case the entire requested amount would be dispensed at the second, lower dispense rate) to 100% of the requested amount (in which case the entire requested amount would be dispensed at the first, higher dispense rate). For two speed dispensing, the transition amount may be adjusted anywhere from 10% to 95% of the requested amount, for example, although any transition amount between 1% and 99% will result in two speed dispensing. It shall be understood, therefore, the magnitude of the transition amount as compared to the requested amount may vary based on the several factors described herein, and that the invention is not limited based on the magnitude of the transition amount or on the magnitude of the transition amount as compared to the requested amount.

As the dispenser dispenses powder product at the second, lower dispense rate, controller 212 continues to monitor the amount (weight) of the product dispensed (212). Controller 150 determines whether the requested amount of powder product has been dispensed (214). The requested amount is an amount requested by a user or determined by the system that results in a use solution having a desired concentration of an active ingredient when mixed with a defined volume of a diluent. If the requested amount has not been dispensed, controller 150 continues to monitor the weight of powder product as it is being dispensed. When the requested amount of powder product has been dispensed (214), controller 150 discontinues the dispense cycle (216).

Adjusting the dispense rate from the first, higher dispense rate to the second, lower dispense rate after the transition criteria has been satisfied may provide several advantages. For example, any time lost during preparation of a new use solution may be minimized by quickly dispensing powder product for the majority of the dispense cycle. Also, dispensing accuracy may be increased by dispensing more slowly as the amount dispensed approaches the requested amount toward the end of the dispense cycle.

The first, higher dispense rate and the second, lower dispense rate may be determined such that preparation time is minimized while dispense accuracy is increased. The relative magnitudes of the first, higher dispense rate and second, lower dispense rate may depend upon several factors, such as the use solution being prepared, the particle size and mass of the powder product, the flow ability of the powder product, the type of powder product (e.g., spray products, gel granules, mixed products, etc.) the specifications and capabilities of the vibration unit, etc. The second, lower dispense rate would typically be something less than the first, higher dispense rate. As one example, the second, lower dispense rate may be between 1% and 90% of the first, higher dispense rate. However, it shall be understood that the dispense rates may vary considerably depending upon these and other factors listed herein, and that the invention is not limited in this respect.

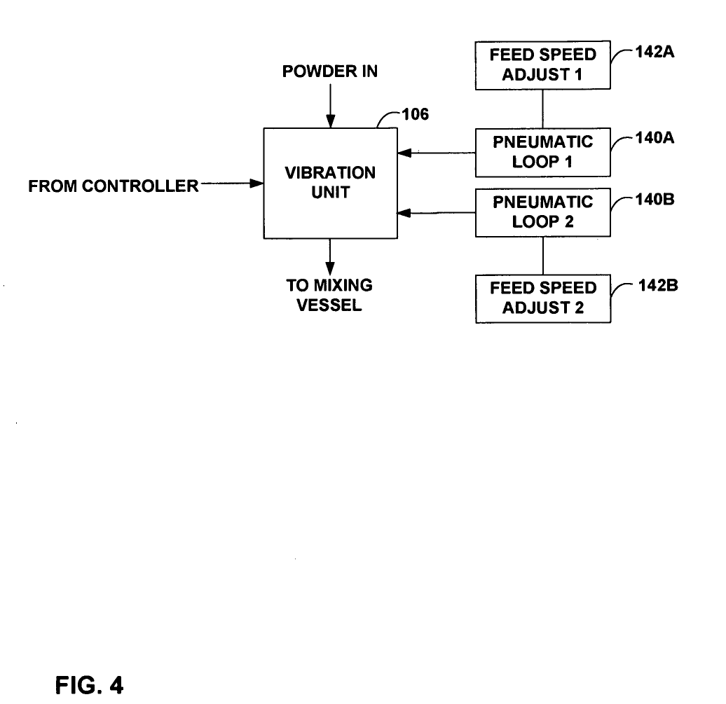

FIG. 4 is a block diagram illustrating an example vibration unit and pneumatic control loops. In this example, vibration unit 106 is a pneumatically controlled vibration unit. Two pneumatic loops 140A and 140B control the first and second dispense rates, respectively, of vibration unit 106. The frequency, and thus the dispense rate, of vibration unit 106 is adjusted by opening or closing of a control valve that controls the flow of pressurized air within each pneumatic loop 140A or 140B. For example, when no powder product is being dispensed, both control valves within pneumatic loops 140A and 140B are closed. To initiate a dispense cycle, the control valve within pneumatic loop 140A is opened. Opening of the control valve allows the flow of pressurized air within pneumatic loop 140A to control the vibration frequency of vibration unit 106 such that vibration unit 106 dispenses powder product 104 being at the first, higher dispense rate. Once the transition criteria has been satisfied, the valve within pneumatic loop 140A is closed and the valve within pneumatic loop 140B is opened. Now, pressurized air within pneumatic loop 140B controls the vibration frequency of vibration unit 106 such that vibration unit dispenses powder product at the second, lower dispense rate. When the requested amount of powder product has been dispensed, pneumatic loop 140B is closed, thus stopping or discontinuing the dispensing of powder product.

Pneumatic loops 140A and 140B are controlled via feed speed adjust 142A and 142B, respectively. Feed speed adjusts 142A and 142B may be manual controls or automatic controls received from controller 150. Feed speed adjusts 142A and 140B control the air pressure provided by the respective pneumatic control loop 140A and 140B. An example pneumatically controlled vibration unit is a Pneumatic Linear Vibrator NTS 180 NF available from Netter Vibration GmbH, Mainz-Kastel, Wiesbaden, Germany. However, it shall be understood that other vibration units could also be used, and that the invention is not limited in this respect.

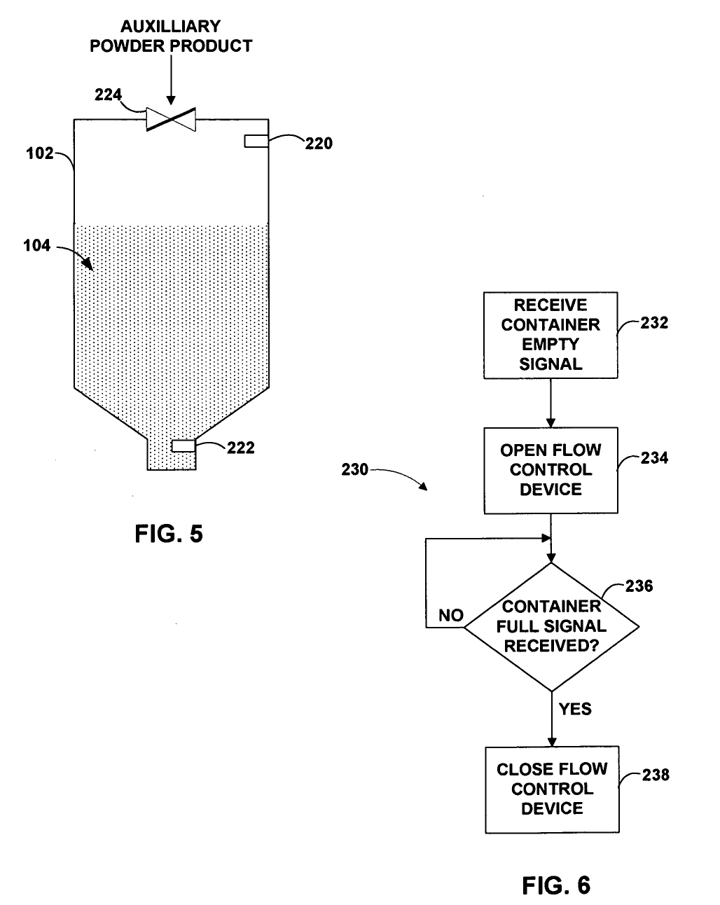

FIG. 5 is a diagram of another example product container 102 that is automatically refillable. Product container 102 may include a container full sensor 220, a container empty sensor 222 and a flow control device 224. Container empty sensor 102 may be positioned near the bottom of product container 102. As powder product is dispensed, the level of powder product 104 within product container 102 decreases until it reaches product empty sensor 222. Once this level is reached, container empty sensor 222 generates a container empty signal. Upon receipt of the container empty signal, full/empty control module 158 within controller 150 may take one or more courses of action. For example, full/empty control module 158 may activate a container empty indicator, such as a visual or audible indicator 162, to notify a user or service technician that the product container needs to be changed or refilled. As another example, controller 150 may initiate and control an automatic refill process. During the automatic refill process, full/empty control module 158 controls operation of automatic refill components 132 (see FIG. 2). Automatic refill components 132 may include a flow control device 224, such as a butterfly valve, that opens in response to the container empty signal and allows additional powder product from an auxiliary source to flow into and refill product container 104.

Although the example shown in FIG. 5 has been described with respects to a butterfly valve, it shall be understood that other types of valves that control the stopping/starting the flow of a powder product may also include a slide valve, pinch valve, arc valve, diaphragm valve, ball valve or other suitable flow control mechanism.

A container full sensor 220 may be positioned near the top of the inside of product container 102. Once the level of powder product 104 within product container 102 reaches container full sensor 220, container full sensor 220 generates a container full signal. Full/empty control module 158 may close flow control device 224 in response to receipt of the container full signal.

Container full sensor 220 and container empty sensor 222 may be implemented using any appropriate device that senses presence or absence of powder product at the desired levels within product container 102. For example, full and empty sensors 220 and 222 may be implemented using capacitive sensors or other analog or electronic sensors that detect presence of powder product by its effect on the electric field created by the sensor. Full and empty sensors 220 and 222 may also be implemented using optical sensors, mechanical sensors or any other suitable type of sensor.

The automatically refillable product container 102 shown in FIG. 5 may provide several advantages. For example, weigh assembly may be selected to store and support up to, for example, a 50 kilogram product container. At the same time, much larger, so-called “big bags” (e.g., 250 kilograms) of auxiliary powder product may be separately stored and supported above product container 102 to facilitate automatic refilling. This permits use of a weigh assembly, such as weigh assembly utilizing load cells, with a smaller nominal load capacity (the designed maximum load cell capacity) e.g., 50 kilograms instead of 250 kilograms in this example. Weigh assemblies with relatively smaller nominal load capacity generally have increased sensitivity compared to load cell(s) having a relatively higher nominal load capacity. This may result in increased dispenser accuracy because smaller changes in the weight of the product container may be detected when weigh assemblies having smaller nominal load capacities are used.

FIG. 6 is a flow chart illustrating one example of the process carried out by controller 150 for automatically refilling a product container. Controller 150 receives the product empty signal from product empty sensor 222 (232). Controller 150 sends a control signal to flow control device (234) causing it to open, thus allowing auxiliary powder product to flow into and refill product container 102 until the container full signal is received from container full sensor 220 (236). Once the container full signal is received (236) controller 150 sends another control signal to flow control device, causing it to close and stop the flow of auxiliary powder product into product container (238).

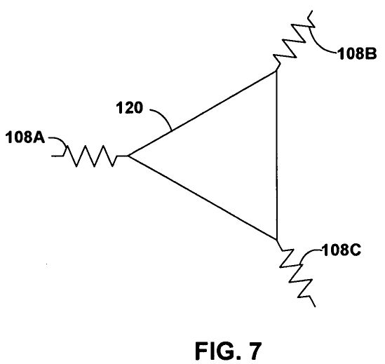

FIG. 7 is a diagram of an example weigh assembly 108. In this embodiment, three load cells 108A, 108B and 108C are evenly distributed about a triangular support platform 120. In the assembled dispenser 100, platform 120 supports product container 102 and vibration unit 104, which are then continuously weighed by the load cells 108A-108C. As shown in this example, three load cells are utilized, although it shall be understood that two or more than three load cells may also be used, and that the invention is not limited in this respect. To determine the current weight of the vibration unit and the product container, controller 150 sums or otherwise combines the signal outputs of the load cell sensors to provide a total weight measurement. Controller 150 may also provide a discrete output from each sensor in the weigh assembly 108. This feature may allow for accurate system calibration as well as providing data that may be used to evaluate the uniformity of the load on support platform 120. Use of multiple load cells may provide better resolution as compared to a single load cell. Multiple load cells also provide accurate weight measurement under varying load conditions such as loads that are distributed unevenly on support platform 120. Multiple load cells also minimize vibration induced single variations. Also, if one load cell fails, it may be possible to compensate using the two surviving load cells and adjustment algorithms.

Although a weigh assembly including at least one load cell is described herein as the means by which the current weight is determined, it shall be understood that the invention is not limited in this respect, and that other digital, analog or other electronic scales or devices for determining weight could also be used.

Various embodiments of the invention have been described. These and other embodiments are within the scope of the following claims.

1. A system comprising:
a dispenser that dispenses a powder product containing an active ingredient from a product container;
a weigh assembly that continuously determines, as the powder product is dispensed, a current weight of the product container; and
a controller that determines when a transition criteria has been satisfied based on the current weight and determines when a requested amount of the powder product has been dispensed based on the current weight of the product container,
wherein the dispenser dispenses at a first, higher dispense rate until the transition criteria has been satisfied and then dispenses at a second, lower dispense rate until a requested amount of the powder product has been dispensed.

2. The system of claim 1, further comprising:
a mixing vessel that receives the dispensed powder product; and
means for adding a diluent to the dispensed powder product in the mixing vessel to form a use solution having a desired concentration of the active ingredient.

3. The system of claim 2, wherein the means for adding a diluent comprises one of a valve or a flow meter.

4. The system of claim 2, further comprising means for delivering a predetermined volume of the use solution from the mixing vessel.

5. The system of claim 2, further comprising means for delivering a predetermined volume of the use solution to at least one dosing point.

6. The system of claim 1, further comprising:
a container full signal that indicates when the product container is full of the powder product; and
a container empty signal that indicates when the product container is substantially empty.

7. The system of claim 6, further comprising:
an automatic refill mechanism responsive to the container empty signal that automatically refills the product container.

8. The system of claim 7, wherein the automatic refill mechanism comprises:
a flow control device that opens in response to the container empty signal and allows additional powder product to flow into the product container, and closes in response to the container full signal.

9. The system of claim 8, wherein the flow control device comprises a butterfly valve.

10. The system of claim 1, further comprising:
means for detecting when the product container is substantially full of the powder product; and
means for detecting when the product container is substantially empty.

11. The system of claim 1, wherein the weigh assembly continuously determines, as the powder product is dispensed, a current combined weight of the product container and the powder product remaining in the product container.

12. The system of claim 1, wherein the controller further controls the dispense rate of the dispenser, initiates a dispense cycle at the first, higher dispense rate, continuously receives the current weight from the weigh assembly, determines when a transition criteria has been satisfied based on the current weight, adjusts the dispense rate to a second, lower dispense rate when the transition criteria has been satisfied, determines when a requested amount of the powder product has been dispensed from the product container based on the combined weight, and discontinues the dispensing of the powder product when the requested amount of the powder product has been dispensed.

13. The system of claim 1, wherein the controller further receives a dispense request, initiates a dispensing cycle at a first, higher rate, determines when the transition criteria has been satisfied, and adjusts the dispense rate to a second, lower rate when the transition criteria has been satisfied.

14. The system of claim 13, wherein the dispenser dispenses the powder product at the second, lower rate until the controller determines that the requested amount of the powder product has been dispensed.

15. The system of claim 13, wherein the second, lower rate is between 1% and 90% of the first, higher rate.

16. The system of claim 1, wherein the transition criteria comprises a transition amount, and wherein the transition criteria has been satisfied when a current weight of product dispensed is greater than the transition amount.

17. The system of claim 16 wherein the transition amount is between 1% and 99% of the requested amount.

18. The system of claim 1, wherein the dispenser comprises a vibration unit that dispenses a predetermined volume of the powder product.

19. The system of claim 1, wherein the dispenser comprises an air-controlled vibration unit, and the system further comprises:
a first pneumatic loop connected to the air-controlled vibration unit that drives the vibration unit at a first, higher dispense rate; and
a second pneumatic loop connected to the air-controlled vibration unit that drives the vibration unit at a second, lower dispense rate.

20. The system of claim 1 further comprising a flowability activator.

21. The system of claim 20, wherein the flowability activator comprises one of a pneumatic hammer, an external electric vibrator, or an external pneumatic vibrator.

22. A method, comprising:
dispensing a powder product containing an active ingredient from a product container at a first, higher dispense rate;
continuously determining, as the powder product is dispensed, a current weight differential of the product container corresponding to a current dispensed amount of powder product;
determining when a transition criteria has been satisfied based on the current weight differential;
adjusting the dispense rate to a second, lower dispense rate when the transition criteria has been satisfied;
determining when a requested amount of the powder product has been dispensed from the product container based on the current weight differential; and
discontinuing the dispensing of the powder product when the requested amount of the powder product has been dispensed.

23. The method of claim 22, further comprising setting the requested amount of the powder product.

24. The method of claim 22, wherein determining the current weight differential comprises comparing an initial weight of the product container with a current weight of the product container.

25. The method of claim 24, wherein comparing the current weight differential to the requested amount comprises determining whether a difference between the current weight differential and the requested amount satisfies a dispensed product threshold.

26. The method of claim 22, further comprising adding a predetermined volume of a diluent to the requested amount of the powder product dispensed to form a use solution having a desired concentration of the active ingredient.
